(19) United States
(12) Patent Application Publication
(10) Pub. No.: US 2022/0391220 A1
(43) Pub. Date: Dec. 8, 2022

(54) DISPLAY DEVICE COMPRISING PLATFORM FOR SWITCHING SOFTWARE SYSTEM

(71) Applicant: Young Su KIM, Suwon-si (KR)

(72) Inventor: Young Su KIM, Suwon-si (KR)

(21) Appl. No.: 17/773,769

(22) PCT Filed: Nov. 3, 2020
(86) PCT No.: PCT/KR2020/015244

§ 371 Date: May 2, 2022

(30) Foreign Application Priority Data
Nov. 7, 2019 (KR) 10-2019-0141729
Oct. 26, 2020 (KR) 10-2020-0138878

(51) Int. Cl. G06F 9/445

(52) U.S. Cl. CPC G06F 9/44505

(57) ABSTRACT

Provided is a display device comprising a platform capable of freely switching a software system to which an operating system and software associated therewith is added, so that the software system can be dedicated to use for specific purposes in diverse fields such as by country or by function. The device comprises a window, a back cover, and a control panel, the control panel comprises a platform control unit for switching a software system composed of an operating system and software associated with the operating system, and the software system comprises any one of a first software system composed of a general-purpose operating system and software associated therewith and a second software system composed of a dedicated operating system and a software system associated therewith, or both thereof.

### TECHNICAL FIELD

The present invention relates to a display device, and more specifically, to a display device including a platform for switching a software system, including a specific operating system, and added with at least one among middleware, an application program, and an app included in an integrated mode, to meet a specific purpose in various fields.

### BACKGROUND ART

A screen of a display device has a display such as a liquid crystal display device (LCD), an organic light emitting diode (OLED), or an electrophoretic display device (EPD). A touch screen is employed in the display device for convenience of handling, and a window for protecting the touch screen from damage by external impact or contact is disposed on the front surface of the touch screen. As flexible and curved displays appear recently, windows corresponding to the displays are introduced. The display device includes an operating system such as Google's Android, Apple's iOS, Samsung's Tizen, Huawei's Kirin, or the like, and software such as middleware, application programs, apps, and the like is linked to the operating system. The software linked to the operating system like this is referred to as a software system.

However, when a specific software system is installed in a conventional display device, it may not be switched to other software. For example, a display device having a software system by Android is not allowed to be switched to an iOS software system while the software system is used. Meanwhile, the software system needs to be used only for a specific purpose in various fields, such as countries like Korea, the United States, and India, and functions of Ministry of National Defense, police, and students. For example, in the case of the Ministry of National Defense, when it is desired to apply a self-developed software system to a display device having an Android operating system, it needs to switch the existing Android software system to a software system for the Ministry of National Defense. In addition, when a user enters India from Korea, switching to a software system used only in India may be required. However, although a method of automatically generating a group app has been proposed in the prior art as shown in Korean Patent Application Laid-Open No. 2012-0069318, there is still no way of switching to a software system for a specific purpose.

### DISCLOSURE OF INVENTION

### Technical Problem

An object of the present invention is to provide a display device including a platform capable of freely switching a software system, to which an operating system and software linked thereto is added, so that the software system may be exclusively used for a specific purpose in various fields such as country, function, and the like.

### Technical Solution

To accomplish the above object, according to one aspect of the present invention, there is provided a display device including a platform for switching a software system, the device comprising: a window, a back cover, and a control board, wherein the control board includes a platform control unit for switching a software system configured of an operating system and software linked to the operating system, and the software system includes any one among a first software system configured of general-purpose operating systems and software linked thereto and a second software system configured of dedicated operating systems and a software system linked thereto, or both of the first and second software systems.

In the device of the present invention, at least one among the window and the back cover may be either a fixed type or a detachable type. At least one among the window and the back cover may include a recognition unit for operating the platform control unit by recognition. The recognition unit may be either a recognition code or a recognition chip. The recognition code may be engraved in the form of a pattern on any one among the window and the back cover.

In the preferred device of the present invention, the control board may be linked to a platform server existing inside or outside the display device, and the platform server may include a platform control unit for storing and switching the software system. The platform control unit of the control board may be interconnected with a recognition unit of at least one among the detachable window and back cover to perform switch of the software system. The control board may be interconnected with a platform control unit of a platform server and a recognition unit of at least one among the detachable window and back cover to perform switch of the software system.

In the device of the present invention, the software linked to the general-purpose operating system or the dedicated operating system may be at least one among middleware, an application program, and an app included in an integrated mode. Switching of the software system may be any one among switching between the first software systems, switching between the first and second software systems, and switching between the second software systems. The software system may be entirely or partially switched. Partial switching of the software system may be activating the software system in parallel. Switching of a software system may be performed in any one among manual, automatic, and artificial intelligence methods. The second software system may be applied only in any one field among country, company, product, organization, and individual.

### Advantageous Effects

According to a display device including a platform for switching a software system of the present invention, as a platform for switching the software system is provided, the software system may be freely switched to meet a specific purpose in various fields. In order to use switching of a software system as big data, access limit is efficiently accomplished.

### BRIEF DESCRIPTION OF THE DRAWINGS

FIG. 1 is a schematic diagram for explaining a display device according to the present invention.

FIG. 2 is a block diagram for explaining a method of switching a software system using a display device according to the present invention.

### BEST MODE FOR CARRYING OUT THE INVENTION

Hereinafter, preferred embodiments of the present invention will be described in detail with reference to the accompanying drawings. The embodiments described below may be modified in various other forms, and the scope of the present invention is not limited to the embodiments described below in detail. The embodiments of the present invention are provided to more completely describe the present invention to those skilled in the art. The drawings are exaggerated for convenience of explanation.

An embodiment of the present invention presents a display device including a platform for freely switching a software system to meet a specific purpose in various fields by providing a platform for switching the software system. To this end, a platform for switching a software system according to various fields will be studied specifically, and a display device including the platform will be described in detail. Here, the platform is provided with a plurality of software systems, and the software systems refer to operating systems and software linked thereto. The operating systems include dedicated operating systems that can be applied in various fields such as country, function, company, product, organization, individual, and the like, as well as general-purpose operating systems such as Android, iOS, Tizen, Kirin, and the like. The general-purpose operating systems are operating systems applied without being limited to a specific field, and the dedicated operating systems are operating systems applied only to the field.

The software linked to the operating systems is at least one among middleware, an application program, and an app included in an integrated mode. The middleware connects different types of hardware, protocols, communication environments, and the like, so that smooth communication may be accomplished between an application program and an environment in which the program operates. The application program includes a program for approval, a program for recognition, a program for security, and the like generated and switched to conform to the software system. The integrated mode includes all kinds of software generated and switched according to the software system. The software includes any one or more pieces of software among one or more apps, background screens, images, music, videos, application programs, and integrated mode operating programs. The integrated mode may include software for producing data, such as a video on YouTube, a service provided by a social network, or the like.

The platform includes a first software system configured of general-purpose operating systems and software linked thereto, as well as a second software system configured of dedicated operating systems and software linked thereto. The first software system is associated with general-purpose operating systems, and the second software system is associated with dedicated operating systems. The platform stores the first and second software systems, and when any one among the first and second software systems is selected, the software system of the display device is switched to the selected system. The first and second software systems may be loaded on the platform.

The dedicated operating systems are applied in various fields such as country, function, company, product, organization, individual, and the like. The country includes Korea, the United States, China, India, and the like, and the function includes defense-related functions, education-related functions, and the like. The company includes Samsung, Apple, Google, Huawei, and the like, and the organization includes government organizations, local government organizations, international organizations, and the like, and the individual is applied to a specific individual and an organization related thereto. Hereinafter, it will be described focusing on a display device including a platform for switching a software system, and an application example of switching a software system using the platform.

Switching of a software system includes switching between first software systems, switching between first and second software systems, and switching between second software systems. An example of the switching between first software systems is switching an Android software system to an iOS software system. An example of the switching between first and second software systems is switching an Android software system to a software system applied only to India. An example of the switching between second software systems is switching from a software system applied only to India to a software system applied only to the Ministry of National Defense of India.

### Display Device

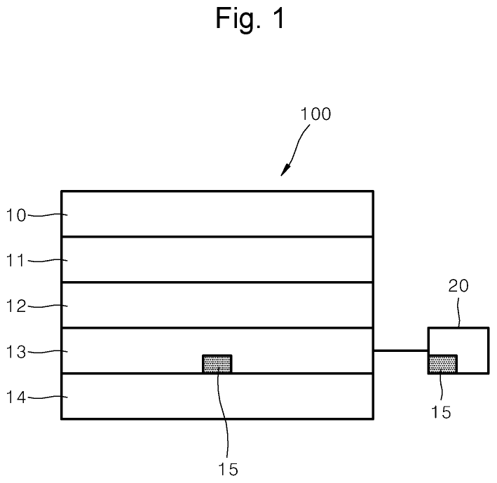

FIG. 1 is a schematic diagram for explaining a display device 100 according to an embodiment of the present invention. However, it does not express a drawing in a strict sense, and there may be components not shown in the drawing for convenience of explanation.

Referring to FIG. 1, the display device 100 includes a window 10, a touch screen 11, a display 12, a control board 13, and a back cover 14. At this point, the window 10 and the back cover 14 may be a fixed type fixed to the touch screen 11 and the control board 13, respectively, or at least one among the window and the back cover 14 may be a detachable type detachably attached to any one among the touch screen 11 and the control board 13. Here, attachment and detachment are functions of detaching and attaching components. The window 10, the touch screen 11, the display 12, the control board 13, and the back cover 14 are already known components and may be variously modified within the scope of the present invention. In some cases, the touch screen 11 may not exist according to the type of the display device 100. The display device 100 is a mobile device, and may include, for example, a smartphone, a tablet PC, a foldable phone, a rollable phone, a notebook computer, and the like.

At this point, the control board 13 may be wiredly or wirelessly connected to a platform server 20 existing inside or outside the display device 100. In addition, although not shown in the drawing, the platform server 20 may be disposed inside the display device 100. The control board 13, the platform server 20, or both of them include a platform control unit 15 for controlling the platform according to an embodiment of the present invention. The platform control unit 15 performs a function of storing and switching software systems. In some cases, the platform control unit 15 may be provided with a communication means for wiredly or wirelessly connecting the control board 13, the window 10, the back cover 14, and the platform server 20 to each other. When the platform server 20 exists outside the display device 100, the platform server 20 may be implemented in various forms such as an external card, a USB, and the like.

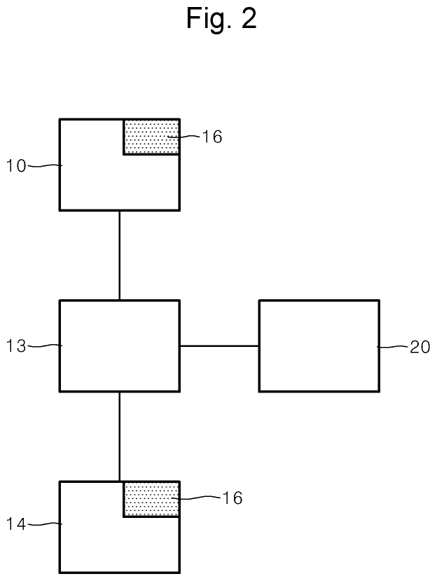

FIG. 2 is a block diagram for explaining a method of switching a software system using a display device according to the present invention. At this point, the display device 100 will be described with reference to FIG. 1.

Referring to FIG. 2, switching software systems of the present invention may be performed in first to fourth methods. The first method is performed using the platform control unit 15 of the control board 13, and the second method is performed by interconnecting the control board 13 and the platform control unit 15 of the platform server 20. The first and second methods may be applied to both a fixed type and a detachable type. The third method is performed by interconnecting a recognition unit 16 of at least one among the detachable window 10 and back cover 14 and the platform control unit 15 of the control board 13. The fourth method is performed by associating the platform control unit 15 of the platform server 20 with the third method.

For the third and fourth methods, at least one among the window 10 and the back cover 14 may include a recognition unit 16 for recognizing a user. The recognition unit 16 operates the platform control unit 15. The recognition unit 16 may include a recognition code or a recognition chip. The recognition code includes a barcode, a QR code, a Braille code, an image code, and the like, and when the recognition unit 16 is recognized by a code reader, the platform control unit 15 may switch the software system. For example, the platform control unit 15 may separate the window, and switch the software system by recognizing the recognition code engraved on the window using a code reader. At this point, the recognition code may be engraved in the form of a pattern on any one among the window 10 and the back cover 14.

When the recognition chip is a passive device, it may switch the software system after recognition is completed through a local area network mounted on the display device 100. When the recognition chip is an active device, at least one among the window 10 and the back cover 14 may be equipped with a means for supplying power to the recognition chip. The power may be supplied by a battery, sunlight, vibration energy, wireless charging, or electromagnetic waves or heat generated by the display device 100. The recognition chip operates by fingerprint recognition, password, eye recognition, face recognition, or the like, and when the recognition chip operates, switch of the software system is performed.

### Application Example of Software System Switch

Hereinafter, a case in which a user using an Android software system in Korea visits India will be described as an example. The example is switching a first software system to a second software system. At this point, it is assumed that India does not use a software system based on the Android operating system, and employs a software system applied only in India. Here, a dedicated software system applied only in India is referred to as an Indian software system. The Indian software system is provided in the platform according to an embodiment of the present invention.

After arriving in India, the user switches the Android operating system to the Indian software system using the platform in any one method among manual, automatic, and artificial intelligence methods. When the user returns to Korea, the user switches the Indian software system to the Android software system using the platform in any one method among manual, automatic, and artificial intelligence methods. Here, in the manual method, the user selects a software system corresponding to the platform of the present invention and switches to the software system, and in the automatic method, when a software system is recognized by the recognition unit 16, a software system is switched to the recognized software system. The artificial intelligence may be automatically performed by artificial intelligence, or a software system may be switched to a software system proposed by the artificial intelligence with approval of the user.

When the Android software system is switched to the Indian software system, software linked to the Indian operating system is also switched, in addition to switching to the Indian operating system. The software linked to the Indian operating system is at least one among middleware, an application program, and an app included in an integrated mode. The integrated mode includes all kinds of software that is changed according to a situation such as user's location, organization, psychology, intention, or the like. The software includes additional software such as one or more apps, background screens, images, music, videos, and the like suitable for a situation. The integrated mode is presented in detail in Korean Patent Application No. 10-2020-0097152. Here, the Android software system may be stored in the memory of the display device, a cloud server, or a server or memory provided by the platform of the present invention before being switched to the Indian software system.

As another example, a case in which a user using an Android software system in Korea visits the Ministry of National Defense of India will be described as an example. The example is switching a first software system to a second software system. Although the user utilizes a first software system linked to a general-purpose operating system in India, the user may select a second software system linked to a dedicated operating system applied only in the Ministry of National Defense of Indian. Like this, switching of a software system according to an embodiment of the present invention may be accomplished in various fields such as country, function, company, product, organization, individual, and the like. For example, when a detachable window engraved with a pattern symbolizing Hermes is mounted on the display device in the United States, a software system related to Hermes may be switched manually, automatically, or by artificial intelligence using the platform.

At this point, the software system may be entirely or partially switched. When the software system is entirely switched, the software system before the switching is completely deactivated, and a switched software system is activated. For example, in the example described above, the Android software system is deactivated, and the Indian software system is activated. When the software system is partially switched, the software system before the switching is partially deactivated, and the switched software system is activated. For example, in the example described above, the Android software system and the software system of the Ministry of National Defense of Indian are activated in parallel.

Recently, utilization of data acts as a catalyst for development of other industries and creates values never seen before. The data is spotlighted as a new resource of a level the same as that of resources such as coal and oil in the era of industrialization. In the data economy, a data access ecosystem is created to lead various downstream industries such as industries of contents, software and hardware. The amount of data created and distributed owing to Internet and smart IT revolution, smartphones, tablet PCs, cloud networks, and the like abruptly increases and forms big data. The big data corresponds to cellular phone call volume, card payment, weather information, social network service (SNS) messages, Internet search details, road traffic, and the like. The big data may be constructed by learning new facts or predicting and setting a development direction while analyzing economic feasibility, technical possibility, and correlation with other fields in each industry. That is, the big data functions as an economic asset and a source of value creation.

However, access to the big data needs to be limited according to utilization purposes, security, or the like. As the value of data resources increases, demands for the access limit increase. In order to efficiently implement the access limit, unwanted access needs to be blocked. Since the dedicated operating system of the present invention is different from general-purpose operating systems, it is relatively safe from hacking, data utilization, and the like. In addition, since data produced by a software system linked to the dedicated operating system is associated with the dedicated operating system, the big data may be utilized more efficiently. At this point, the scope of access limit varies according to a field such as country, function, company, product, organization, or individual.

As described above, although the present invention has been described in detail with reference to a preferred embodiment, the present invention is not limited to the embodiment, and various modifications may be made by those skilled in the art within the scope of the technical spirit of the present invention.

DESCRIPTION OF SYMBOLS

| | |
|---|---|
| 100: Display device | |
| 10: Window | 11: Touch screen |
| 12: Display | 13: Control board |
| 14: Back cover | 15: Platform control unit |
| 16: Recognition unit | 20: Platform server |

1. A display device including a platform for switching a software system, the device comprising:
a window, a back cover, and a control board, wherein
the control board includes a platform control unit for switching a software system configured of an operating system and software linked to the operating system, and the software system includes any one among a first software system configured of general-purpose operating systems and software linked thereto and a second software system configured of dedicated operating systems and a software system linked thereto, or both of the first and second software systems.

2. The device according to claim 1, wherein at least one among the window and the back cover is either a fixed type or a detachable type.

3. The device according to claim 1, wherein at least one among the window and the back cover includes a recognition unit for operating the platform control unit by recognition.

4. The device according to claim 3, wherein the recognition unit is either a recognition code or a recognition chip.

5. The device according to claim 4, wherein the recognition code is engraved in a form of a pattern on any one among the window and the back cover.

6. The device according to claim 1, wherein the control board is linked to a platform server existing inside or outside the display device, and the platform server includes a platform control unit for storing and switching the software system.

7. The device according to claim 1, wherein the platform control unit of the control board is interconnected with a recognition unit of at least one among the detachable window and back cover to perform switch of the software system.

8. The device according to claim 1, wherein the control board is interconnected with a platform control unit of a platform server and a recognition unit of at least one among the detachable window and back cover to perform switch of the software system.

9. The device according to claim 1, wherein the software linked to the general-purpose operating system or the dedicated operating system is at least one among middleware, an application program, and an app included in an integrated mode.

10. The device according to claim 1, wherein switching of the software system is any one among switching between the first software systems, switching between the first and second software systems, and switching between the second software systems.

11. The device according to claim 1, wherein the software system is entirely or partially switched.

12. The device according to claim 1, wherein partial switching of the software system is activating the software system in parallel.

13. The device according to claim 1, wherein switching of a software system is performed in any one among manual, automatic, and artificial intelligence methods.

14. The device according to claim 1, wherein the second software system is applied only in any one field among country, company, product, organization, and individual.
